(19) United States
(12) Patent Application Publication
(10) Pub. No.: US 2003/0003933 A1
(43) Pub. Date: Jan. 2, 2003

(54) Mobile client for multi-service provider network environment

(75) Inventors: Nikhil M. Deshpande, Beaverton, OR (US); Jeffrey G. Yarne, Portland, OR (US)

Correspondence Address: Schwegman, Lundberg,, Woessner & Kluth, P.A., P.O. Box 2938, Minneapolis, MN, 55402, US

(73) Assignee: Intel Corporation

(21) Appl. No.: 09/893,038

(22) Filed: Jun. 27, 2001

(51) Int. Cl. H04B 7/00

(52) U.S. Cl. 455/510; 455/509

(57) ABSTRACT

In an area being serviced by multiple wireless network access service providers, a service provider is selected for use by a communication device based upon information received from each of the available service providers and a provider selection criterion.

### FIELD OF THE INVENTION

The invention relates generally to communication systems and, more particularly, to techniques and structures for providing wireless network access and services within a communication system.

### BACKGROUND OF THE INVENTION

There is an increasing need for network access solutions (e.g., Internet access, corporate intranet access, etc.) for mobile users. For example, many professionals are finding it increasingly important to stay in contact with associates, clients, and others while they are traveling on business or are otherwise away from the office. Often, these professionals require a relatively high-bandwidth network connection that can support high volume information transfer. To meet this need, many systems are in development or are currently being deployed that provide wireless network access points (APs) in high traffic areas such as, for example, airports, train stations, hotels, convention centers, shopping malls, coffee shops, and others. Such locations have been labeled “hot spots” because they are areas where communication services are typically in high demand. Many companies are currently active, or are considering becoming active, in the provision of wireless network access services to mobile users. For this and other reasons, it is predicted that many “hot spot” locations will eventually be serviced by multiple competing network access service providers having overlapping coverage areas.

### BRIEF DESCRIPTION OF THE DRAWINGS

FIG. 1 is a diagram illustrating a communication device that is located within an area that is serviced by multiple wireless network access service providers;

FIG. 2 is a block diagram illustrating internal functionality within a communication device in accordance with an embodiment of the present invention; and

FIG. 3 is a flowchart illustrating a method for establishing a wireless network connection for a communication device in accordance with an embodiment of the present invention.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the fall range of equivalents to which the claims are entitled. In the drawings, like numerals refer to the same or similar functionality throughout the several views.

The present invention relates to methods and structures for providing wireless network access for mobile users. A mobile client function is implemented within a communication device to manage the procurement of network access services for an associated user when, for example, the user is mobile (i.e., away from a tethered access). While in a particular location, the mobile client determines the availability of wireless network access services (i.e., access points) in the vicinity. If the mobile client determines that multiple APs are available at that location, it interrogates each of the APs to obtain information relating to the available services. The mobile client then selects one of the available APs based on the information received from the APs and a user-specific selection criterion. A network connection is then established for the communication device using the selected AP.

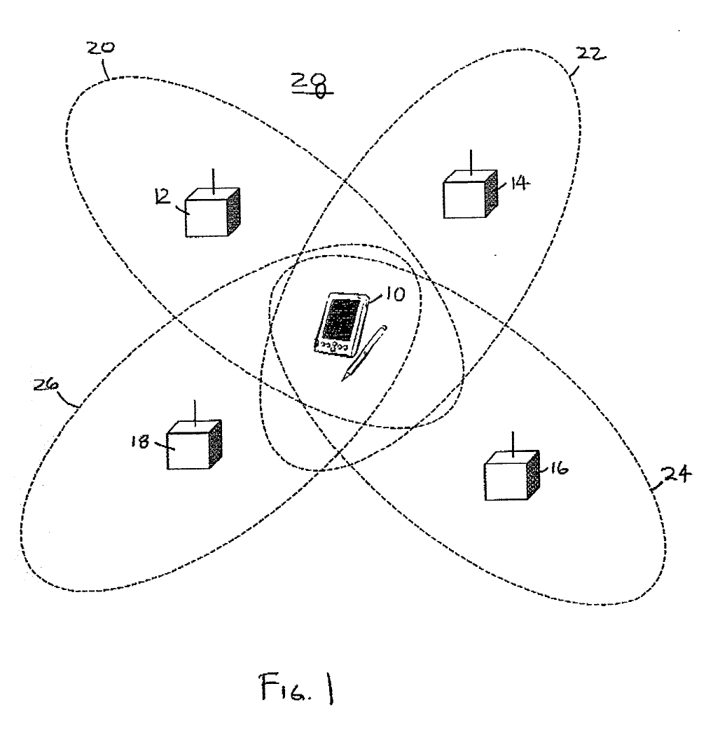

FIG. 1 is a diagram illustrating a communication device 10 that is located within an area 28 (e.g., a hot spot) that is serviced by multiple wireless network access service providers 12, 14, 16, 18. Each of the network access service providers has a corresponding coverage region 20, 22, 24, 26 within the area 28 in which it provides services. As illustrated, the coverage regions 20, 22, 24, 26 of the network access service providers 12, 14, 16, 18 overlap within the area 28. The communication device 10 is located in a position that is encompassed by each of the coverage regions 12, 14, 16, 18. Thus, the communication device 10 can theoretically achieve network access (e.g., to the Internet, a corporate intranet, etc.) through any one of the available providers. Each of the network access service providers 12, 14, 16, 18 will generally have one or more service offerings that users can take advantage of. These service offerings will most likely differ from provider to provider in attributes such as cost and performance. In addition, special service arrangements may exist between the user (or the user's employer) and one or more of the service providers. In one aspect of the present invention, therefore, functionality is provided within a communication device for selecting a network access service provider in a multi-provider environment.

The communication device 10 of FIG. 1 can include any of a wide variety of digital information handling devices including, for example, a personal digital assistant (PDA), a portable personal computer (e.g., a laptop), a cellular telephone, a pager, and others. Typically, these will be devices that support internet protocol (IP) connectivity. The communication device 10 is equipped with wireless transceiver functionality that allows the device to establish and maintain a wireless communication link with an external entity. The wireless transceiver functionality within the communication device can be compatible with any of a number of different wireless standards including, for example, wireless local area network (WLAN), IEEE 802.11(a), IEEE 802.11(b), Bluetooth, HomeRF, HiperLAN, and others. Multiple wireless standards may also be supported. Some companies currently providing wireless network access services include: Mobilestar, Aerzone, Airwave, Wayport, Sonera, and Telia.

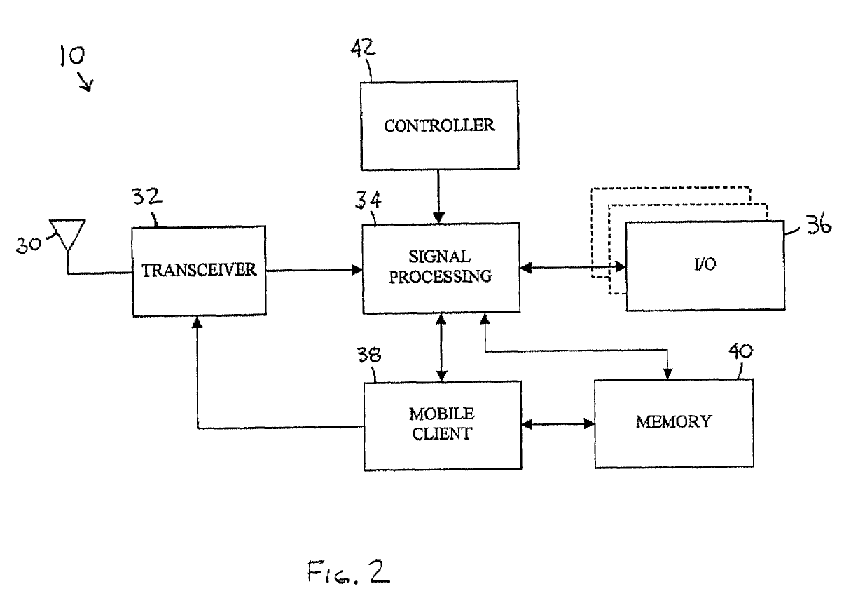

FIG. 2 is a block diagram illustrating functionality within the communication device 10 of FIG. 1 in accordance with an embodiment of the present invention. As illustrated, the communication device 10 includes: an antenna 30, a wireless transceiver 32, a processing unit 34, one or more input/output (I/O) devices 36, a mobile client 38, a memory 40, and a controller 42. It should be appreciated that the individual blocks illustrated in FIG. 2 do not necessarily represent discrete hardware elements. For example, in at least one embodiment, two or more of the functional blocks are implemented in software within a digital processing device (e.g., a general purpose microprocessor, a digital signal processor (DSP), a reduced instruction set computer (RISC), a field programmable gate array (FPGA), etc.). Multiple digital processing devices can also be used. Full hardware implementations are also possible.

The wireless transceiver 32 includes radio frequency (RF) transmit and receive functionality. The transmit functionality is operative for converting baseband transmit information output by the processing unit 34 into a radio frequency transmit signal that can be transmitted by the antenna 30. The receive functionality is operative for converting a radio frequency signal received by the antenna 30 into a baseband format that is recognizable by the processing unit 34. Although illustrated as a single unit, the transmit and receive functionality of the transceiver 32 can be implemented separately. Separate transmit and receive antennas can also be used. The I/O device(s) 36 can include any of a wide variety of devices for inputting information from and/or outputting information to a user associated with the communication device 10. The particular I/O devices 36 that are present will usually depend upon the type of communication device 10 being used. For example, if the communication device 10 is a portable computer, the I/O devices 36 may include a keyboard, a pointing device (e.g., a mouse, a touchpad, etc.), a display, a sound card with associated speakers and microphone, and/or others. If the communication device 10 is a PDA, the I/O devices 36 may include, for example, a display, a pointing device (e.g., a stylus), control buttons, and/or others. Many other types of I/O devices 36 are also possible.

The processing unit 34 is operative for processing baseband data within the communication device 10 under the control of the controller 42. For example, in one possible function, the processing unit 34 may be called upon to process information received by the transceiver 32 from a remote entity to covert the information to a format that can be displayed to the user via an I/O device 36. In another possible function, the processing unit 34 may be required to retrieve stored digital information from the memory 40 and to process the information for delivery to the transceiver 32 to be transmitted to a remote entity. As will be appreciated, the processing unit 34 will typically be capable of performing a wide variety of information processing tasks.

The mobile client 38 is operative for managing external wireless network connections for the communication device 10 while the associated user is away from a base location (e.g., when the user is traveling on business, etc.). In a preferred approach, the mobile client 38 will perform its management function with little or no user interaction. The mobile client 38 will typically have a priori knowledge of the network access service providers that are commonly active in hot spot locations. In one embodiment, for example, a unique radio network name (e.g., an ESS ID) is stored within the communication device 10 (e.g., within the memory 40) for each of the possible network access service providers. The mobile client 38 will be able to access this information during normal device operation. Other information about the service providers may also be stored within the communication device 10 including, for example, subscriber ID, network connectivity, security features available (e.g., certificate authority), personal profile information, billing units and consumed units, pricing plans and/or negotiated prices, network interoperability or service interoperability (e.g., reciprocal billing information), preferred plans or services, and/or other information.

To establish a network connection for the communication device 10, the mobile client 38 will first typically identify the service providers that are presently active in the vicinity of the device 10. In one approach, the mobile client 38 will cause one or more wireless inquiry signals to be transmitted from the antenna 30. Service providers that are currently active in the area will then respond to the inquiries with return signals. The mobile client 38 will then prepare a list of available providers based on the return signals received. Each of the inquiry signals that are transmitted may include, for example, the radio network name of a corresponding provider. In one approach, the mobile client 38 progresses through a list of stored radio network names, transmitting an inquiry for each listed provider. Alternatively, a single inquiry signal can be transmitted that is directed to all of the available providers. Providers that are available can then transmit return signals having their corresponding radio network names therein. Any of a number of different multiple access or collision avoidance techniques can be used to differentiate the return signals. In another approach, each of the providers that are active in an area can periodically transmit an identification signal (e.g., a beacon) that can be detected by communication devices within the coverage area thereof. The mobile client 38 can then prepare a list of providers based on the identification signals it has detected in the vicinity (i.e., from the beacons). As will be appreciated, other techniques for identifying active service providers in the vicinity of the communication device 10 are also possible.

If multiple service providers have been identified as being active in an area, the mobile client 38 will interrogate each of the identified providers for information relating to their service offerings. The interrogation will typically involve the transmission of wireless interrogation signals to the identified providers using the transceiver 32 and the antenna 30. The mobile client 38 may interrogate each service provider for information relating to, for example, the cost of its services, any discounts that may be available, any prearranged roaming agreements that may be in effect between the provider and the user (or the user's employer), and/or other cost related information. Similarly, the mobile client 38 may interrogate each service provider for information relating to the quality and/or performance (e.g., speed) of the connection that will be furnished by the provider should its services be used. For example, each provider may be queried for the total number of users currently being serviced by the provider in this location and for the total available bandwidth of the provider in this location. This information can then be used by the mobile client 38 to estimate the effective per user bandwidth that the provider is currently able to support (e.g., by dividing total bandwidth by number of users). Instead of estimating per user bandwidth, the mobile client 38 may perform a direct measurement of the available bandwidth during the interrogation. For example, in one embodiment, the mobile client 38 requests a short (e.g., 5 seconds) temporary network connection from each provider during which the bandwidth of the connection can be directly measured. Methods for measuring the bandwidth of wireless connections are known. Both instantaneous and average bandwidth values can be measured.

After the mobile client 38 has received and analyzed the information from the service providers, the client 38 selects one of the providers based on user-specific connection preferences. In one approach, the user maintains a stored user profile within the communication device 10 that includes the user's connection preferences (e.g., a file stored within the memory 40). The mobile client 38 retrieves the stored profile information for use in selecting a provider. The profile may indicate, for example, that the least expensive provider is always to be used. Alternatively, the profile may indicate that the provider having the highest per user bandwidth capability is to be selected. A more complex user selection criterion can also be specified within the stored profile. For example, a weighted sum of cost and performance can be used as a criterion. Similarly, limits can be placed on one or more of the selection variables (e.g., the least expensive provider that can provide a per user bandwidth greater than X). Special preference can also be given to selected providers within the profile (e.g., for similar cost and bandwidth, always select provider A over provider B). Such preferential treatment can be given when, for example, the user (or the user's employer) has a preestablished relationship with a particular provider (e.g., frequent user benefits). In one embodiment, the user selection profile is stored on a removable memory card (e.g, a subscriber identification module (SIM)) that the user can insert into a communication device when network access is desired. Such a card would allow the user to procure network access services according to his preferences when using a communication device other than his own (e.g., via a network access kiosk, etc.). As will be appreciated, any number of different selection criteria can be stored within the user profile.

In an alternative approach, the mobile client 38 will prompt the user for a selection criterion to use during the selection process. For example, in one embodiment, the user is presented with a menu of possible selection criteria each time a selection needs to be made. The user then selects a criterion using an input device (e.g., a mouse or stylus). The mobile client 38 may also include functionality that allows the user to preestablish whether an automatic or prompted selection criterion will be used. If the user has setup the mobile client 38 to use an automatic selection criterion, for example, a stored user profile will be used. If the user has setup the mobile client 38 to use a prompted selection criterion, on the other hand, the user will be prompted for a criterion each time a provider selection is to be made.

Situations may exist where additional information is needed from the user to make an optimal provider decision. For example, one provider may be cheaper if the connection does not exceed 20 minutes in length while another will be cheaper for longer connections. In such circumstances, the mobile client 38 can prompt the user for the additional information needed to make the selection (e.g., prompt the user for the approximate length of the desired connection). In another scenario, the mobile client 38 can assemble the information gathered about each available provider and then present all or some of this information to the user (e.g., through a display) and allow the user to make the ultimate selection. In one approach, the mobile client 38 narrows down the decision to a subset of the available providers before presenting the information to the user.

In one embodiment of the invention, the mobile client 38 is configured to continuously operate in the background whenever the communication device 10 is turned on and away from a base location (e.g., not hardwired to a corporate network). In another embodiment, the mobile client 38 is configured so that the user has to activate it when a wireless network connection is desired (e.g., by double clicking on an icon, etc.). The mobile client 38 may also include functionality that allows the user to preset the client 38 for either continuous or user activated operation. Once the mobile client 38 has been activated and a provider selection has been made, the client 38 can continue to monitor the providers in the area to determine whether a switch to another provider is warranted. For example, if the user moves to a new location within the area 28, the communication device 10 may leave the coverage area of the selected provider. The mobile client 38 can then automatically select a new provider that is active in the new location (e.g., using the same selection criteria that was previously used). Even without moving, the mobile client 38 may identify another provider that is now offering a “better deal” than the selected provider (e.g., less expensive, more bandwidth, etc.) and switch to this provider. Preferably, the switch to the new provider will be seamless, providing minimal to no interruption to the user. As will be appreciated, other scenarios requiring a change of provider also exist.

The mobile client 38 can be implemented in any of a variety of ways. In one approach, for example, the mobile client 38 is implemented as a software application that is loaded into a digital processing device within the communication device 10. Thus, a mobile client program can be stored on a computer readable medium (e.g., a compact disk read only memory (CD ROM), a magnetic storage disk, a semiconductor memory, etc.) for user installation into a communication device. In another approach, the mobile client functionality is embedded within a semiconductor chip that is an integral part of the communication device. In yet another embodiment, the mobile client is implemented as middleware. Other techniques for implementing the mobile client functionality within a communication device also exist.

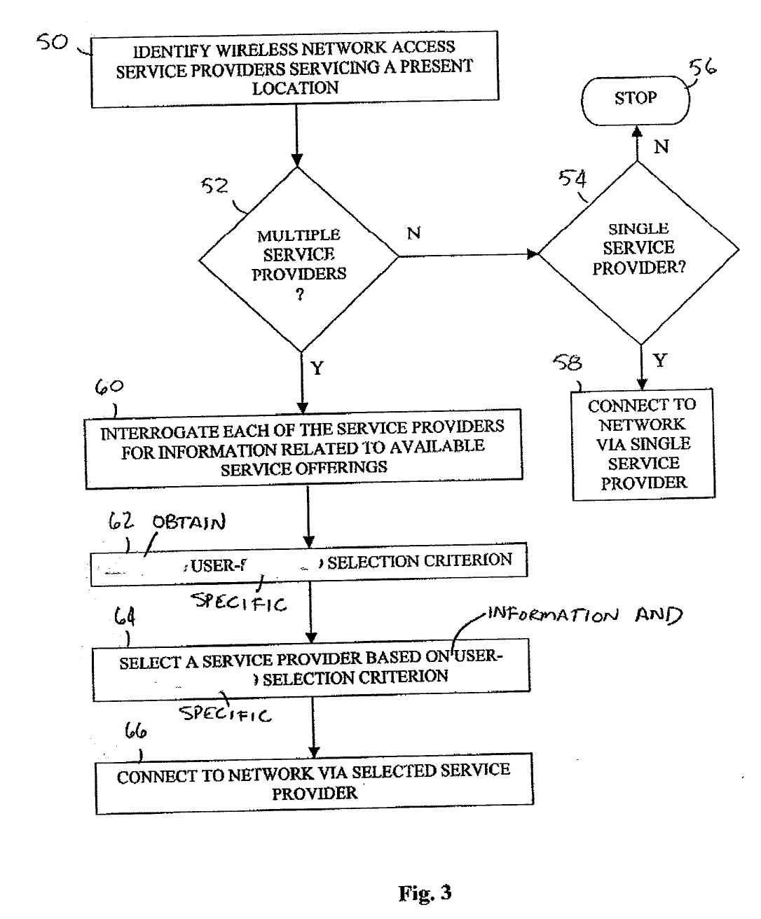

FIG. 3 is a flowchart illustrating a method for establishing a wireless connection to a network for a communication device in accordance with an embodiment of the present invention. First, wireless network access service providers servicing a present location of the communication device are identified (block 50). In one approach, wireless inquiries are transmitted to each of a set of known service providers and wireless responses are received from service providers that service the location of the communication device. It is next determined whether multiple service providers have been identified (block 52). If multiple service providers have been identified, each of the identified service providers are interrogated for information relating to their present service offerings (block 60). For example, each of the service providers can be interrogated for information related to the cost of using the provider's services. Similarly, the service providers can each be interrogated for information related to the quality and/or performance of the connection that the provider can presently supply. A selection criterion is obtained for use in selecting a provider (block 62). The selection criterion can be obtained from a storage unit within the communication device or directly from the user. A service provider is then selected based upon the information received from the identified service providers and the user-specific selection criterion (block 64). A connection is subsequently made to the network using the selected service provider (block 66). If only a single service provider has been identified in block 50, then that provider is used to provide the network connection (blocks 54 and 58). If no service provider is identified in block 50, the process is stopped (blocks 54 and 56). The user can then move to a different location and attempt access again. Connection to the network will usually require that authentication and authorization of the user be performed.

Although the present invention has been described in conjunction with certain embodiments, it is to be understood that modifications and variations may be resorted to without departing from the spirit and scope of the invention as those skilled in the art readily understand. Such modifications and variations are considered to be within the purview and scope of the invention and the appended claims.

What is claimed is:

1. A communication device comprising:
means for interrogating a plurality of wireless network access service providers to gather information related to service offerings thereof;
means for obtaining a provider selection criterion associated with a user of said communication device; and
means for selecting a service provider from said plurality of wireless network access service providers to provide wireless access to a network for said communication device based on said provider selection criterion and said information.

2. The communication device of claim 1, wherein:
said means for interrogating includes means for wirelessly transmitting a separate interrogation signal for each of said plurality of wireless network access service providers.

3. The communication device of claim 1, wherein:
said means for interrogating includes means for wirelessly transmitting a separate interrogation signal for each of said plurality of wireless network access service providers, said separate interrogation signal including an identifier uniquely identifying a corresponding service provider.

4. The communication device of claim 1, wherein:
said information includes information related to a cost of service offered by a first wireless network access service provider.

5. The communication device of claim 1, wherein:
said information includes in formation related to a connection performance available from a first wireless network access service provider.

6. The communication device of claim 1, wherein:
said information includes information related to a per user bandwidth available from a first wireless network access service provider.

7. The communication device of claim 1, wherein:
said means for interrogating a plurality of wireless network access service providers includes means for measuring a connection bandwidth associated with a first wireless network access service provider.

8. The communication device of claim 1, wherein:
said means for interrogating a plurality of wireless network access service providers includes means for requesting a relatively short duration connection from a first wireless network access service provider to allow a connection bandwidth of said first wireless network access service provider to be measured by said communication device.

9. The communication device of claim 1, wherein:
said means for obtaining a provider selection criterion includes means for retrieving said provider selection criterion from a memory within said communication device.

10. The communication device of claim 1, wherein:
said means for obtaining a provider selection criterion includes means for prompting a user of said communication device for said provider selection criterion using an input/output device.

11. The communication device of claim 1, wherein:
said means for obtaining a provider selection criterion includes means for reading said provider selection criterion from a removable memory card.

12. The communication device of claim 11, wherein:
said means for reading includes means for reading said provider selection criterion from a subscriber identification module (SIM).

13. A method for procuring wireless access to a network for a communication device, comprising:
identifying a plurality of network access service providers that are currently servicing a present location of the communication device;
interrogating said plurality of network access service providers for information using a wireless interrogation signal; and
selecting a service provider from said plurality of network access service providers based on said information and a selection criterion.

14. The method of claim 13, wherein:
identifying a plurality of network access service providers includes transmitting at least one inquiry signal and receiving response signals from at least two network access service providers.

15. The method of claim 13, wherein:
interrogating includes transmitting a first wireless interrogation signal to a first network access service provider, said first wireless interrogation signal including an identifier uniquely identifying said first network access service provider.

16. The method of claim 13, wherein:
interrogating includes transmitting a first wireless interrogation signal to a first network access service provider, said first wireless interrogation signal requesting information related to a cost of service associated with said first network access service provider.

17. The method of claim 13, wherein:
interrogating includes transmitting a first wireless interrogation signal to a first network access service provider, said first wireless interrogation signal requesting information related to a quality of service available from said first network access service provider.

18. The method of claim 13, wherein:
interrogating includes transmitting a first wireless interrogation signal to a first network access service provider, said first wireless interrogation signal requesting information related to a per user bandwidth associated with said first network access service provider.

19. The method of claim 13, comprising:
retrieving said selection criterion from a memory within said communication device for use in selecting said service provider.

20. The method of claim 13, comprising:
obtaining said selection criterion from said user via an input/output device associated with said communication device.

21. The method of claim 13, wherein:
said selection criterion is user-specified.

22. A computer readable medium having program instructions stored thereon for performing, when executed within a digital processing device, a method for procuring wireless access to a network, said method comprising:
interrogating a plurality of network access service providers for information relating to service offerings; and
selecting a service provider from said plurality of network access service providers based on said information and a selection criterion.

23. The computer readable medium of claim 22, wherein:
interrogating includes causing a first wireless interrogation signal to be transmitted to a first network access service provider, said first wireless interrogation signal requesting information related to a cost of service associated with said first network access service provider.

24. The computer readable medium of claim 22, wherein:
interrogating includes causing a first wireless interrogation signal to be transmitted to a first network access service provider, said first wireless interrogation signal requesting information related to a quality of service available from said first network access service provider.

25. The computer readable medium of claim 22, wherein said method includes:
identifying a plurality of network access service providers that are currently active in a location before interrogating.

26. A communication device comprising:
a wireless transceiver to transmit communication signals into and receive communications signals from a wireless communication channel via at least one antenna; and
a mobile client to procure wireless access to a network for the communication device, said mobile client including:
an interrogation function to interrogate a plurality of network access service providers that are active in a vicinity of said communication device using interrogation signals transmitted by said wireless transceiver, said interrogation function receiving information from said plurality of network access service providers in response to said interrogation signals; and
a selection function to select a service provider from said plurality of network access service providers based on said information received by said interrogation function and a provider selection criterion.

27. The communication device of claim 26, comprising:
a memory to store said provider selection criterion, wherein said selection function retrieves said provider selection criterion from said memory for use in selecting said service provider.

28. The communication device of claim 26, wherein:
said selection function prompts a user of said communication device for said provider selection criterion using an input/output device of said communication device.

29. The communication device of claim 26, wherein:
said mobile client further includes an identification function for identifying said plurality of network access service providers that are active in said vicinity of said communication device for use by said interrogation unit.

30. The communication device of claim 26, comprising:
a memory including a list of network access service providers that provide network access services to the public, said plurality of network access service providers that are active in said vicinity of said communication device representing a subset of said service providers on said list.

31. The communication device of claim 30, wherein:
said list of network access service providers includes a radio network name for each of said network access service providers.
